(19) United States
(12) Patent Application Publication
(10) Pub. No.: US 2022/0327198 A1
(43) Pub. Date: Oct. 13, 2022

(54) NEW PERMISSION APPROVAL AUTHORITY

(71) Applicant: Hewlett-Packard Development Company, L.P., Spring, TX (US)

(72) Inventors: Shell S. Simpson, Boise, ID (US); Jason Anthony Grundy, Boise, ID (US)

(73) Assignee: Hewlett-Packard Development Company, L.P., Spring, TX (US)

(21) Appl. No.: 17/765,879

(22) PCT Filed: Nov. 1, 2019
(86) PCT No.: PCT/US2019/059381

§ 371 Date: Apr. 1, 2022

(51) Int. Cl. G06F 21/45; G06F 21/62; G06F 21/31

(52) U.S. Cl. CPC G06F 21/45; G06F 21/629; G06F 21/31

(57) ABSTRACT

Examples disclosed herein relate to receiving a request from an entity to be granted a new permission, identifying, within a hierarchy of entities, a lowest level manager with approval authority for the new permission, determining whether the lowest level manager with approval authority for the new permission has approved the entity to be granted the new permission, and, in response to determining that the lowest level manager with approval authority for the new permission has approved the entity to be granted the new permission, applying a policy statement associated with the new permission to the entity.

### BACKGROUND

Information technology environments often support numerous users who may have differing levels of access to various features of the environment. For example, some users may have access to log in to and/or manage certain devices, such as computers and/or printers. Other users may have administrative access to control access to those features.

### BRIEF DESCRIPTION OF THE DRAWINGS

FIG. 1 is a block diagram of an example approval hierarchy.

FIG. 2 is a block diagram of an example computing device for providing a new permission approval authority.

FIG. 3 is a block diagram of an example system for providing a new permission approval authority.

FIG. 4 is a flowchart of an example method for providing a new permission approval authority.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

in many electronic environments, multiple device may be managed by applying permission policies to various entities. For example, an environment may have a plurality of users with different access permissions, such as the ability to access, use, configure, upgrade, administer, and/or maintain those devices. Such users and devices may belong to groups within the environment; devices may belong to groups associated with a device type, such as color printer devices and laptops, to a group associated with a location, such as New York City devices, mobile devices, and/or San Francisco devices, and/or to administrative groups such as devices assigned to a particular customer, partner, and/or business unit. Similarly, users may be grouped by location, job function, managerial level, and/or administrative privileges. Such examples are presented only to illustrate the concept and are not intended to be limiting; numerous other entity groupings for users and devices may be utilized by the examples herein.

Managing these users and their permissions may become challenging. In an enterprise, for example, managed services may have multiple types of users including employees, customers, partners (that may resell the managed services), and those partners' customers. Each of these users may have roles that span across various systems and devices, such as sales and/or shipping systems or hardware assets. For example, a user from a partner may have an administrator role that may be scoped to only apply to the assets being managed by a customer of that partner. In many situations, managing user roles across multiple systems and scopes may be challenging because it becomes unclear who is responsible for approving authorization.

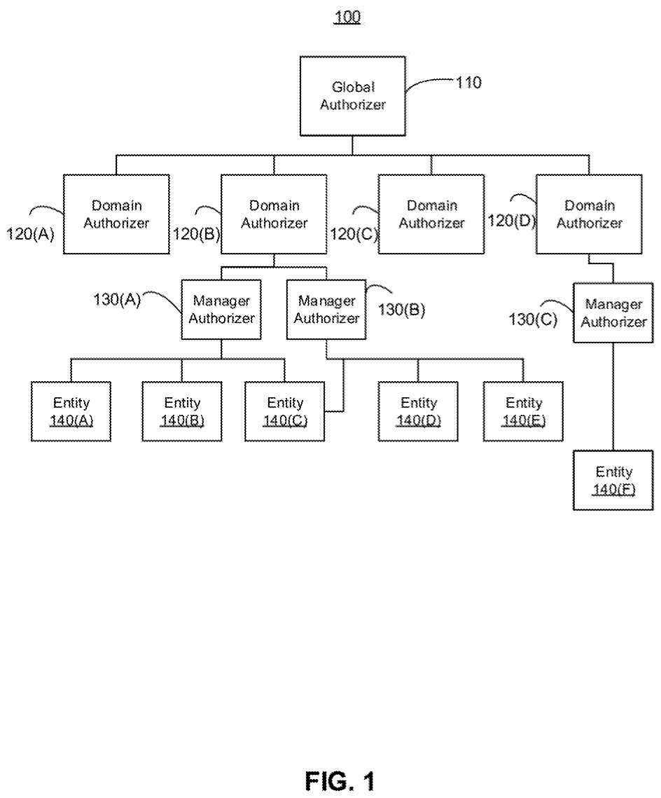

FIG. 1 is a block diagram of an example approval hierarchy 100. Approval hierarchy 100 may comprise a global authorizer 110 with supervisory authority over a plurality of domain authorizers 120(A)-(D). Domain authorizers 120(A)-(D) may have supervisory authority over a plurality of manager authorizers 130(A)-(C). As illustrated in approval hierarchy 100, domain authorizer 120(B) has supervisory authority over manager authorizers 130(A)-(B) while domain authorizer 120(D) has supervisory authority over manager authorizer 130(C). Manager authorizers 130(A)-(C) may in turn have supervisory authority over a plurality of entities 140(A)-(F). In some implementations, supervisory authority over entities 140(A)-(F) may be shared among multiple manager authorizers, such as manager authorizers 130(A) and 130(B) each having supervisory authority over entity 140(C).

As used in the example approval hierarchy 100, each authorizer and/or entity may be associated with one and/or more permissions, each defined by a policy statement. Each policy statement may in turn be defined by a role and a scope. For example, a role may comprise a defined action that can be taken by an entity 140(A)-(F), such as ability to access a network, log in to a device, use specific functionality, create, revoke, suspend, and/or approve permissions, enter and/or modify data, etc. A scope may be defined as a single entity and/or a set of entities, such as devices of a particular type and/or a department within an organization (e.g., printers assigned to a sales group), users in a group and/or location (e.g., users assigned to the 4^{th} floor of Building C). Numerous other scopes are contemplated, and these are offered only as examples without intending to be limiting.

Putting these elements together, each authorizer 110, 120(A)-D), 130(A)-(C) and/or entity 140(A)-(F) may comprise one and/or more policy statements giving them permission to act in a role within a defined scope. For example, domain authorizer 120(B) may comprise a policy statement granting permission to approve permission requests from Manager Authorizers 130(A)-(B). Such a policy statement may, in some implementations, be transitive to other authorizers and/or entities, such as Entity 140(A)-(E) that report up through Manager Authorizers 130(A)-(B) within hierarchy 100. For another example, entity 140(B) may comprise a user entity comprising a policy statement granting permission to print on entity 140(C) comprising a printing device entity.

Hierarchy 100 may be defined by a global authorizer 110 that may comprise the highest approver in the hierarchy, with the ability to approve any permission policy for any other authorizer and/or entity. Domain authorizers 120(A)-(D) and manager authorizers 130(A)-(C) may comprise tiers of approvers within hierarchy 100 with each manager authorizer in the hierarchy comprising authority limited in scope based on their higher level domain authorizer. For example, global authorizer 110 may comprise an administrator associated with a company that provides a product and/or service. Each domain authorizer 120(AMD) may comprise an administrator associated with a partner reseller for the company's product. Each manager authorizer 130(A)-(C) may comprise an end customer for the respective partner reseller. Thus, the global authorizer can establish and approve permissions for all users of the product and/or service, while the manager authorizers may be limited to products and/or services purchased by their specific organization.

Hierarchies such as hierarchy 100 may not be limited to such a setup—another example may apply within an organization, such as where global authorizer 110 may comprise an internal IT administrator, each domain authorizer 120(A)-(D) may be associated with a business unit, and each manager authorizer 130(A)-(C) may be associated with a site location. Entities 140(A)-(F) may then have more than one manager authorizer with the scope to approve permissions for some and/or all roles associated with those entities. In some implementations, hierarchy 100 may comprise a hierarchy level defined using one and/or more Internet domain names. For example, entities associated with an email address from a given domain (e.g., mail.com) may be associated with a domain overseen by a specific domain authorizer.

In some implementations, an entity, such as entity 140(E) comprising an employee user, may desire a new permission, such as printing on entity 140(D) comprising a printing device entity. Entity 140(E) may request permission to access entity 140(D) through a tool such as a web-based user interface. In some implementations, a lowest level authorizer within the hierarchy may be identified such as by traversing each authorizer within the hierarchy to identify an authorizer comprising a policy statement comprising a permission approval role in a scope including entity 140(D). In the example of hierarchy 100, manager authorizer 130(B) may comprise a policy statement providing such a permission approval role, and so may receive the request from entity 140(E) to approve print access to entity 140(D). If manager authorizer 130(B) does not comprise such a permission approval role, other manager authorizers under the same domain authorizer 120(B) may be checked for the appropriate role, such as manager authorizer 130(A). In some implementations, neither manager authorizer 130(A) or manager authorizer 130(B) may comprise the appropriate permission approval role, and/or one of the manager authorizers 130(A)-(B) may wish to seek higher level approval for the request. In such an example, the request may be escalated to domain authorizer 120(B) and/or global authorizer 110 to seek approval or denial of the request.

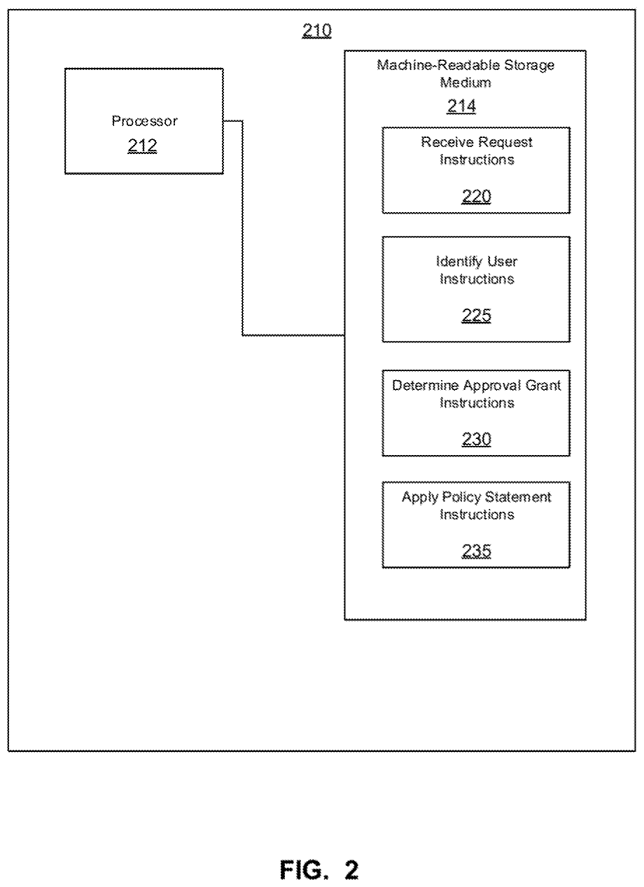

FIG. 2 is a block diagram of an example computing device 210 for providing new permission approval authority. Computing device 210 may comprise a processor 212 and a non-transitory, machine-readable storage medium 214. Storage medium 214 may comprise a plurality of processor-executable instructions, such as receive request instructions 220, identify user instructions 225, determine approval grant instructions 230, and apply policy statement instructions 235. In some implementations, instructions 220, 225, 230, 235 may be associated with a single computing device 210 and/or may be communicatively coupled among different computing devices such as via a direct connection, bus, or network.

Processor 212 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 214. In particular, processor 212 may fetch, decode, and execute instructions 220, 225, 230, 235.

Executable instructions 220, 225, 230, 235 may comprise logic stored in any portion and/or component of machine-readable storage medium 214 and executable by processor 212. The machine-readable storage medium 214 may comprise both volatile and/or nonvolatile memory and data storage components. Volatile components are those that do not retain data values upon loss of power. Nonvolatile components are those that retain data upon a loss of power.

The machine-readable storage medium 214 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random-access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Receive request instructions 220 may receive a request from an entity to be granted a new permission. In some implementations, the new permission may be role and/or scope based. For example, the new permission may comprise a role associated with actions that may be taken by an entity and/or a scope associated with one and/or more entities on which an action may be taken. For example, a role may comprise a defined action that can be taken by an entity 140(A)-(F), such as ability to access a network, log in to a device, use specific functionality, create, revoke, suspend, and/or approve permissions, enter and/or modify data, etc. A scope may be defined as a single entity and/or a set of entities, such as devices of a particular type and/or a department within an organization (e.g., printers assigned to a sales group), users in a group and/or location (e.g., users assigned to the 4^{th} floor of Building C). Numerous other scopes are contemplated, and these are offered only as examples without intending to be limiting.

Identify user instructions 225 may identify a user with approval authority for the new permission. For example, a plurality of users and devices may comprise various entities and authorizers associated with hierarchy 100. Each entity and/or authorizer may be associated with one and/or more policy statements, each comprising a role and a scope as described above. In some implementations the scope may comprise one and/or more physical and/or digital assets, such as a printer, computer, service, and/or application.

In some implementations, identify user instructions 225 may comprise instructions to identify a type of the request as at least one of the following: a specific request and a free-form request. A free-form request may comprise, for example, a text name for the new permission. A specific request may comprise a known permission for the new permission, such as may be selected from a drop-down list of permissions enumerated based on available approval policy statements associated with a manager authorizer in the hierarchy above the requesting entity.

In some implementations, the user with approval authority for a specific request may comprise a lowest approver in a hierarchy of approval users with approval authority for the new permission. For example, in example hierarchy 100, a known permission may be requested by Entity 140(E). If manager authorizer 130(C) does not comprise the appropriate policy to approve the requested permission, the request may be escalated to domain authorizer 120(D) for approval.

In some implementations, the user with approval authority for a free-form request may comprise a lowest approver in a hierarchy of approval users with approval authority for any permission related to the entity. For example, a user comprising Entity 140(B) may request a permission to access a computing device comprising Entity 140(E) by entering a textual request for “login access to device <identifier>, where identifier may be a name, network address, unique ID number, etc. that identifies Entity 140(E) to device 210. Instructions 225 may identify manager authorizer 130(C) as the lowest approver in hierarchy 100 with an associated policy statement granting permission approval authority over Entity 140(E) in this example.

In some implementations, instructions 225 may comprise instructions to receive an escalation response from the lowest approver in the hierarchy of approval users and notify a next lowest approver in the hierarchy of approval users of the request. For example, a user comprising Entity 140(A) may request access to a computing device comprising Entity 140(B). Manager Authorizer 130(A) may comprise the lowest approval authority in hierarchy 100, but may not wish to approve the request directly, despite having an associated policy giving Manager Authorizer 130(A) the authority to approve the request. Manager Authorizer 130(A) may use a user interface tool to escalate the request and instructions 225 may automatically identify the next lowest approver in hierarchy 100; in this example, Domain Authorizer 120(B), and forward the request to that approver.

Determine approval grant instructions 230 may determine whether the user with approval authority for the new permission has granted the new permission to the entity.

Apply policy statement instructions 235 may in response to determining that the user with approval authority for the new permission has granted the new permission to the entity, apply a policy statement associated with the new permission to the entity. For example, the entity may be associated with a series of policy statements, such as may be stored in a database or file structure. Each policy statement may identify the role and scope of an authorized permission. Upon approval by the user with approval authority, such as manager authorizer 130(A), instructions 235 may apply a new and/or updated policy statement granting the requested permission to an entity such as Entity 140(A), which may comprise a user, device, and/or other asset (e.g., a software application), for example.

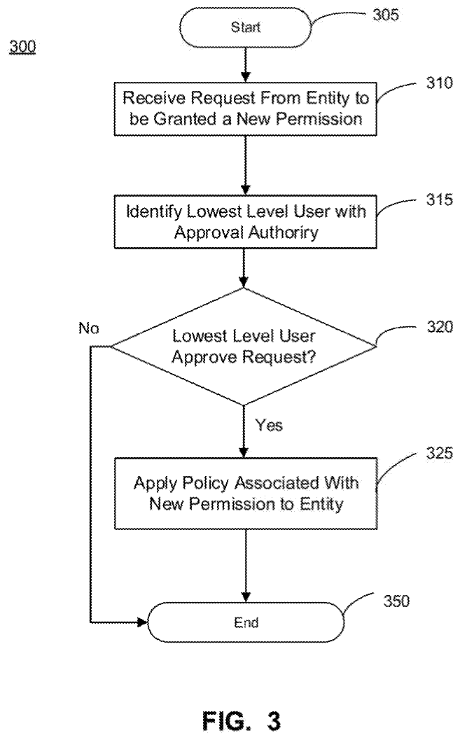

FIG. 3 is a flowchart of an example method 300 for new permission approval authority. Although execution of method 300 is described below with reference to computing device 210, other suitable components for execution of method 300 may be used.

Method 300 may begin at stage 305 and advance to stage 310 where device 210 may receive a request from an entity to be granted a new permission.

In some implementations, the new permission may comprise a request type comprising at least one of the following: a known permission and a free-form permission. For example, a user entity such as Entity 140(A) may access a user interface tool to request permission to print to a printer entity, such as Entity 140(D). In some example implementations, the user interface tool may display, such as in a drop-down list, known permissions based on the permission approval policies associated with a manager authorizer associated with Entity 140(A), such as Manager Authorizer 130(A). If manager authorizer 130(A) has a permission approval role with a scope comprising Entities 140(A)-(C), those permissions may comprise known permissions and may be displayed for selection on the user interface tool. For other permissions, Entity 140(A) may need to provide a free-form permission request, such as typing in text to describe the requested permission. For example, the user comprising Entity 140(A) may enter “print role for print device <description>” where <description> corresponds to an identifier for Entity 140(D).

Method 300 may then advance to stage 315 where computing device 210 may identify, within a hierarchy of entities, a lowest level manager with approval authority for the new permission. In some implementations, identifying, within the hierarchy of entities, the lowest level manager with approval authority for the new permission comprising a free-form permission may comprise identifying the lowest level user with approval authority for any permission associated with the entity. For example, in the case described above, a user entity comprising Entity 140(A) may request permission to print to a printer entity, such as Entity 140(D). The user may enter a free form type of request, and device 210 may identify manager authorizer 130(B) as the lowest level manager associated with permission approval policies over Entity 140(D). Device 210 may traverse the hierarchy, such as by beginning at Entity 140(D) and examining all entities and/or authorizers with policies associated with Entity 140(D) to find one with an appropriate permission approval policy. In some implementations, the lowest level manager with approval authority may comprise the lowest level manager in the hierarchy with a policy statement granting approval authority for the requested permission and/or the requesting entity instead of and/or in addition to the entity for which the permission is being requested.

Method 300 may then advance to stage 320 where computing device 210 may determine whether the lowest level manager with approval authority for the new permission has approved the entity to be granted the new permission.

In response to determining that the lowest level manager with approval authority for the new permission has approved the entity to be granted the new permission, method 300 may then advance to stage 325 where computing device 210 may apply a policy statement associated with the new permission to the entity.

Method 300 may then end at stage 350.

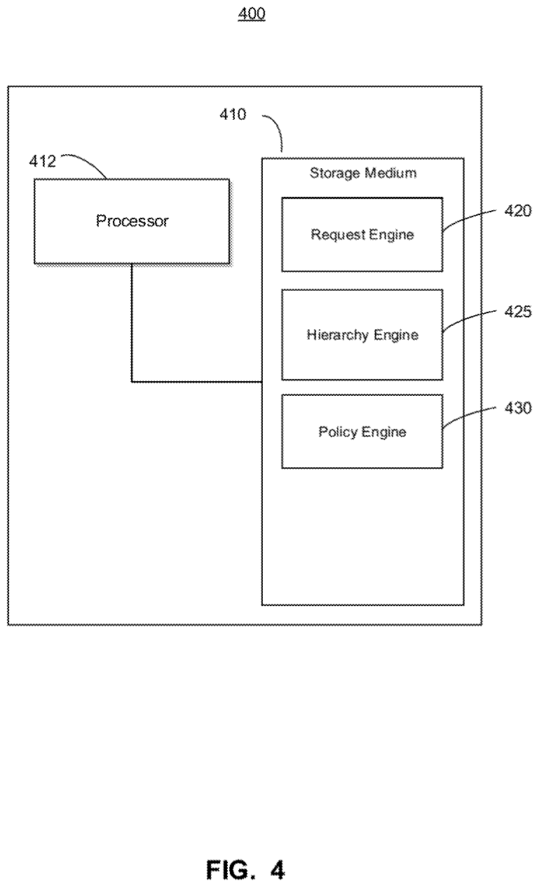

FIG. 4 is a block diagram of an example system 400 for providing new permission approval authority. System 400 may comprise a computing device comprising a storage medium 410, and a processor 412. System 400 may comprise and/or be associated with, for example, a general and/or special purpose computer, server, mainframe, desktop, laptop, tablet, smart phone, game console, printer, multi-function device, and/or any other system capable of providing computing capability consistent with providing the implementations described herein. System 400 may store, in storage medium 410, a request engine 420, a hierarchy engine 425, and a policy engine 430.

Each of engines 420, 425, 430 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 420, 425, 430. In such examples, device 402 may comprise the machine-readable storage medium storing the instructions and the processing resource to execute the instructions, or the machine-readable storage medium may be separate but accessible to apparatus 300 and the processing resource.

Request engine 420 may receive a request from an entity to be granted a new permission and identify a type of the request as at least one of the following: a specific request and a free-form request. For example, request engine 420 may execute receive request instructions 220 as described above.

Hierarchy engine 425 may identify, within a hierarchy of users, a lowest level user with approval authority for the new permission according to the type of the request, and determine whether the lowest level user with approval authority for the new permission has approved the entity to be granted the new permission. For example, hierarchy engine 425 may execute identify user instructions 225 as described above.

In some implementations, hierarchy engine 425 may receive an escalation response from the lowest approver in the hierarchy of approval users and notify a next lowest approver in the hierarchy of approval users of the request.

Policy engine 430 may, in response to determining that the lowest level user with approval authority for the new permission has approved the entity to be granted the new permission, apply a policy statement associated with the new permission to the entity. For example, policy engine 430 may execute determine approval grant instructions 230 and apply policy statement instructions 235, as described above.

In the foregoing detailed description of the disclosure, reference is made to the accompanying drawings that form a part hereof, and in which is shown by way of illustration how examples of the disclosure may be practiced. These examples are described in sufficient detail to allow those of ordinary skill in the art to practice the examples of this disclosure, and it is to be understood that other examples may be utilized and that process, electrical, and/or structural changes may be made without departing from the scope of the present disclosure.

What is claimed is:

1. A non-transitory machine readable medium storing instructions executable by a processor to:
receive a request from an entity to be granted a new permission;
identify a user with approval authority for the new permission;
determine whether the user with approval authority for the new permission has granted the new permission to the entity; and
in response to determining that the user with approval authority for the new permission has granted the new permission to the entity, apply a policy statement associated with the new permission to the entity.

2. The non-transitory machine readable medium of claim 1, wherein the new permission is role-based.

3. The non-transitory machine readable medium of claim 1, wherein the instructions to identify the user with approval authority for the new permission comprise instructions to identify a type of the request as at least one of the following: a specific request and a free-form request.

4. The non-transitory machine readable medium of claim 3, wherein the free-form request comprises a text name for the new permission.

5. The non-transitory machine readable medium of claim 3, wherein the specific request comprises a selected, known permission for the new permission.

6. The non-transitory machine readable medium of claim 3, wherein the user with approval authority for a specific request comprises a lowest approver in a hierarchy of approval users with approval authority for the new permission.

7. The non-transitory machine readable medium of claim 3, wherein the user with approval authority for a free-form request comprises a lowest approver in a hierarchy of approval users with approval authority for any permission related to the entity.

8. The non-transitory machine readable medium of claim 7, wherein the instructions to identify the user with approval authority for the new permission further comprise instructions to:
receive an escalation response from the lowest approver in the hierarchy of approval users; and
notify a next lowest approver in the hierarchy of approval users of the request.

9. The non-transitory machine readable medium of claim 7, wherein the hierarchy of approval users comprises a plurality of users each associated with at least one authority statement comprising a role and an asset scope.

10. The non-transitory machine readable medium of claim 1, wherein the hierarchy of approval users comprises a hierarchy level defined by an internet domain.

11. A method comprising:
receiving a request from an entity to be granted a new permission;
identifying, within a hierarchy of entities, a lowest level manager with approval authority for the new permission;
determining whether the lowest level manager with approval authority for the new permission has approved the entity to be granted the new permission; and
in response to determining that the lowest level manager with approval authority for the new permission has approved the entity to be granted the new permission, applying a policy statement associated with the new permission to the entity.

12. The method of claim 11, wherein the new permission comprises a request type comprising at least one of the following: a known permission and a free-form permission.

13. The method of claim 12, wherein identifying, within the hierarchy of entities, the lowest level manager with approval authority for the new permission comprising a free-form permission comprises identifying the lowest level manager with approval authority for any permission associated with the entity.

14. A system, comprising:
a request engine to:
receive a request from an entity to be granted a new permission, and
identify a type of the request as at least one of the following: a specific request and a free-form request;
a hierarchy engine to:
identify, within a hierarchy of users, a lowest level user with approval authority for the new permission according to the type of the request, and
determine whether the lowest level user with approval authority for the new permission has approved the entity to be granted the new permission; and
a policy engine to:
in response to determining that the lowest level user with approval authority for the new permission has approved the entity to be granted the new permission, apply a policy statement associated with the new permission to the entity.

15. The system of claim 14, wherein the hierarchy engine is further to:
receive an escalation response from the lowest approver in the hierarchy of approval users; and
notify a next lowest approver in the hierarchy of approval users of the request.
